(19) United States
(12) Patent Application Publication
(10) Pub. No.: US 2024/0392860 A1
(43) Pub. Date: Nov. 28, 2024

(54) IMPROVED CLAMP FOR USE IN A LIFTING ASSEMBLY

(71) Applicants: Vincent BYRNE, Banff (GB); IronGrip AB, Stocksund (SE)

(72) Inventors: Vincent BYRNE, Banff (GB); Håkan LOTHIGIUS, Stocksund (SE); Leif SCHIAVONE, Stocksund (SE)

(73) Assignee: IronGrip AB, Stocksund (SE)

(21) Appl. No.: 18/684,115

(22) PCT Filed: Aug. 16, 2021
(86) PCT No.: PCT/SE2021/050796

§ 371 Date: Feb. 15, 2024

(51) Int. Cl. F16G 11/14; B66C 1/12

(52) U.S. Cl. CPC F16G 11/143; B66C 1/12

(57) ABSTRACT

Embodiments herein relate to an improved clamp for use in lifting assemblies. The clamp includes a through passage for receiving a rope and a hook element for holding a coupling element of the rope, and during lifting, the part of the rope between the coupling element and the through passage of the clamp forms a tightenable noose of rope. The clamp is arranged to lock the noose when the lifting assembly is in use.

### TECHNICAL FIELD

Embodiments herein relate in general to lifting assemblies for lifting a load, and especially to an improved clamp for use in such lifting assemblies. The clamp comprises a through passage for receiving a rope and a hook element for holding a coupling element of the rope, and during lifting, the part of the rope between the coupling element and the through passage of the clamp forms a tightenable noose of rope. The clamp is arranged to lock the noose when the lifting assembly is in use.

### BACKGROUND

Rope slings are commonly used in industry and construction for lifting objects, such as a bundle of pipes or other objects to be moved from one place to another. When the load is lifted, the rope slings tighten around the bundle due to the weight of the load. Assemblies of this type comprises a rope having a coupling element at one end thereof, and a clamp comprising a through passage for receiving the rope and a hook element for holding the coupling element of the rope. During lifting the part of the rope between the coupling element and the through passage of the clamp forms a tightenable noose of rope. The tightenable noose of rope for engaging the load is known as a reeved eye. A rope having a reeved eye is referred to as rope sling. Rope slings are commonly used in industry and construction for lifting objects, such as a bundle of pipes or other objects. When lifted the rope slings tighten around the bundle.

In lifting assemblies of this type, the rope has a stretched diameter when the rope is under tension of the load, and an unstretched diameter, when the rope is unloaded. The unstretched diameter is marginally larger than the stretched diameter, and in that the internal diameter of the through passage of the clamp and the rope are mutually adapted such that the through passage clamps the rope having the unstretched diameter and releases the rope having the stretched diameter. The stretched diameter of a specific rope depends on the rope diameter when not under tension, the load applied to the rope and the stretchability of the rope.

The stretching characteristics of the rope are suitable for clamping the rope in the passage when the load is laid down and releasing the rope during lifting. The internal diameter of the passage in the clamp and the specific rope used are mutually adjusted such that the clamp does not compress the rope when it is under tension of the load, while after releasing the load the rope thickens marginally so as to be firmly clamped in the passage. As a result, the clamp only compresses the rope when this is required—when the load is laid down in a resting position but still coupled to the lifting assembly.

During lifting or lowering the load, the clamp does not exert substantial compressional forces to the rope as it is stretched as a result of the tension therein. Although the stretched rope can still be in contact with the internal walls of the through passage of the clamp during lifting, the stretched rope will more or less freely slide through the passage. Then, hoisting a load does not apply any friction on the rope and, consequently, the rope sling does not experience a substantial decrease of the safe working load. Thus, the useful working life of the rope sling is increased.

The clamp always applies the correct compression forces onto the unstretched rope. An operator cannot screw the clamp disclosed herein too tight or too slight. A still further advantage is that the structure basically is very simple, and easy to handle by the user.

In such lifting assemblies, the internal diameter of the through passage of the clamp is equal to or smaller than the unstretched diameter of the rope and larger than the stretched diameter of the rope. As mentioned above the stretched diameter of the rope depends inter alia on the tension in the rope, which is caused by the load applied. A higher load will cause a smaller stretched diameter. After removal of the load, the rope expands marginally to its unstretched diameter. Depending on the relation between the internal diameter of the passage and the rope diameter, the stretched rope may be in loose or close contact with the internal walls of the passage. The internal diameter of the passage is larger than the stretched diameter of the rope. Then, the stretched rope can freely slide through the passage. If the internal diameter of the passage is equal to or even marginally less than the stretched rope diameter, the rope will experience increased wear while sliding through the passage. However, this wear is still little compared to the wear of the rope extending through the known sliding hook discussed above. The relation between the internal diameter of the through passage in the clamp and the stretched rope diameter depends on the desired operation.

In general, the through passage of the clamp will be essentially undeformable such that the internal diameter of the passage is fixed. In this case, the internal diameter of the passage in the clamp cannot vary. The slipping of the rope through the passage when the rope is under load is caused entirely by the stretching of the rope.

The coupling element comprises an eye, and the clamp is provided with a first body member and a second body member, which body members each comprise a receiving portion, wherein the body members can be attached to each other such that the receiving portions form the through passage, and wherein during use the rope extends through the eye. This involves several advantages, as will now be elucidated.

The hook element is attached to at least one body member of the clamp, and wherein the hook element is adapted for holding the eye of the rope when the rope extends through the eye and the passage. The rope is passed through the eye for defining a reeved eye for engaging the load. The hook element encompasses the eye of the rope, i.e. the hook element grips around the wire of the eye from the side. The body member having the hook element is attached to the other body member. Together the body members encompass around the rope above the eye. Thus, the rope extending through the passage essentially runs along the longitudinal axis of the clamp during lifting. In other words, the clamp will orientate itself to the direction of the angle of the wire. The mutual alignment of the rope and the clamp during lifting further reduces the risk of imparting compressional forces onto the rope under tension. Moreover, the reeved eye tightens firmly in this case.

In embodiments herein, the hook element protrudes with respect to the body parts, and wherein the hook element has a curved shape that is adapted for holding the eye. The curved shape of the hook element essentially corresponds to the stretched and unstretched diameter of the rope.

In this case the hook element has an open side for inserting the eye of the rope in the hook element, and wherein the rope, when extending through the passage of the clamp, confines the eye of the rope received in the hook element. Thus, the assembly is adapted such that during use the eye of the rope is caught between the hook element and the rope that extends through the passage.

It may be possible that the rope has a pulling end that is opposed to the end having the eye, and wherein the pulling end is suitably arranged for connection with a hook or other lifting or hauling device. For example, the pulling end is provided with a further eye that can be held by a crane hook.

The rope may comprise a number of materials. Advantageously, the rope comprises a steel wire. A steel wire is commonly used for off-shore applications.

Embodiments herein discloses a clamp for a lifting assembly as described above. In particular, such a clamp can be described in independent form as a clamp for a rope, comprising a through passage for receiving the rope and a hook element for holding a coupling element at one end of the rope. The dimensions of the through passage of the clamp are adapted for clamping a rope when unloaded and releasing the rope when under tension. Advantageously, the coupling element comprises an eye, and the clamp is provided with a first body member and a second body member, which body members each comprise a receiving portion, wherein the body members can be attached to each other such that the receiving portions form the through passage for receiving the rope. Preferably, a hook element is attached to at least one body member of the clamp, and wherein the hook element is adapted for holding the eye of the rope when the rope extends through the eye and the passage.

When such lifting devices are in use, it is often in dangerous environments and situations, such as on a cargo ship in a harbor when heavy loads are to be lifted from the cargo ship to other transportations. When handling bundles of long and heavy pipes, like pipes for use in an oil rig, it is very important to ensure safe working arrangements for the users of such lifting arrangements.

A dangerous work step is to place and lock/unlock the clamp of a lifting arrangement when a lift procedure of load is either about to start or is completed. Standard clamps may for example be provided with a loose bolt and a nut that needs to be very precisely fitted into holes of different parts of the clamp. There is a risk of losing the bolt, or the nut, or both. Another risk is if such clamps are assembled from several parts connected to each other i.e. by a bolt or the like, that different parts of the lifting arrangement may be separated from each other and lost. Loosing the bolt or any part of the clamp may result in a heavy load not being able to be secured in a safe way with damages to people or property as a possible outcome.

Thus, there is a need of improved safety when locking and unlocking load in such lifting arrangements. An object of embodiments herein is to provide an improved clamp for use in an assembly for lifting a load, which increases safety for the user and enables improved performance when in use.

### SUMMARY

Embodiments herein relates to a clamp for use in a lifting assembly comprising a coupling element with at least one rope with an eye. The clamp is provided with a first body member and a second body member. The body members each comprises a respective receiving portion. The body members are attached to each other by an attachment arrangement such that the receiving portions form a through passage. The first body member further comprises a hook element being adapted to receive and hold the eye of the rope when the rope extends through the eye to form a loop, and through the through passage of the clamp. The attachment arrangement comprises a first and a second hole arranged in the respective receiving portion and a coupling element arranged to pass through the first and second holes thereby attaching the receiving portions to each other, and arranged to be attached to the first body member when the receiving portions are separated from each other. It is to be noted that no load is carried by the clamp—the load is totally carried by the rope.

In embodiments herein, coupling element have a first part with a first diameter, and a second part with a second diameter. The first diameter is larger than the second diameter.

In embodiments herein, the diameter of the first part of the coupling element substantially corresponds to the diameter of the first hole. Further, the diameter of the first and second holes may be equal to each other. Alternatively, one of the first and second holes may be elongated. Still further, the first and second holes may be displaced in relation to each other. In embodiments herein, the coupling element may be a bolt provided with threads and a head, and the first and second holes may be provided with corresponding threads.

The hook element protrudes with respect to the body parts, and the hook element has a curved shape that is adapted for holding the eye. The hook element has an open side for applying the eye of the rope on the hook element, and the rope, when extending through the passage of the clamp, confines the eye of the rope received in the hook element. The closed side of the hook element may be provided with a reinforcement part.

In embodiments herein a lifting assembly comprising such a clamp is provided.

### BRIEF DESCRIPTION OF DRAWINGS

FIG. 1 shows a perspective view of two assemblies for lifting a load with a bundle of pipes.

FIGS. 2 and 3 shows an example of a clamp 3 in an open, unused state.

FIG. 3 also shows the clamp in an open state.

FIGS. 4 and 5 show the clamp in a closed state.

FIG. 6 shows the clamp from the underside.

FIGS. 7a and 7b is cross sectional views of the clamp.

FIG. 8 shows the clamp from the side in a closed state.

FIG. 9 shows the clamp from above.

FIG. 10 shows the clamp from the side in a half-open state.

### DETAILED DESCRIPTION

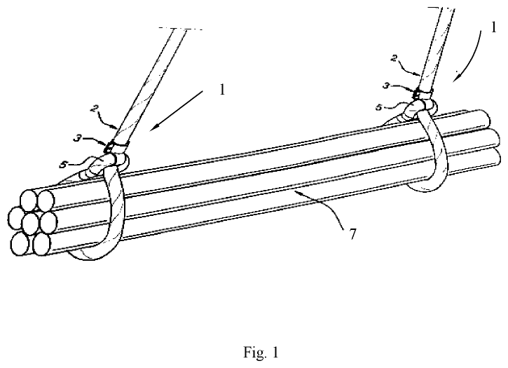

FIG. 1 shows a perspective view of two assemblies for lifting a load with a bundle of pipes. With reference to FIG. 1, a lifting assembly will now be described. The assembly for lifting a load 1 comprises a wire rope 2 and a clamp 3. The rope 2 has an eye 5, which is formed by a fixed loop at one end of the rope 2. The end of the rope opposed to the eye 5 provides a pulling end. The pulling end may also comprise a further eye that will be held by a crane or other hoisting device in operation not shown. The rope 2 forms a reeved eye for engaging the load by passing the pulling end of the rope 2 through the eye 5. The rope 2 thus constitutes a rope sling. The two rope slings are tightly noosed around a plurality of pipes to form a pipe bundle. The ropes extend along the vertical during lifting. This implies that two hoisting devices, e.g. two hooks, are provided, each hook lifting one rope, respectively. In practice, the two ropes are usually connected to one single hoisting device. Then, the ropes are inclined with respect to the vertical. This influences the working load limit of the rope slings. When the body parts 9, 10 are placed onto each other, the through passage 17 defined by the internal faces 11, 12 of the receiving portions 15, 16 has an internal diameter. The internal diameter of the through passage 17 is fixed as long as the body parts are attached to each other.

In off-shore applications the rope 2 usually comprises a steel wire. When the rope 2 is unloaded, it has an unstretched diameter. The rope 2 will stretch when it is under tension of a load, which will decrease the diameter of the rope 2. When lifting a load the rope 2 becomes thinner than in the unloaded state. Thus, the stretched diameter of the rope is marginally smaller than the unstretched diameter of the rope 2. The internal diameter of the through passage 17 is adapted such that the passage clamps the rope 2 when it has its unstretched diameter and releases the rope 2 when it has its stretched diameter. In other words, the passage 17 clamps the rope 2 when the load is laid down, but the passage is inactive during hoisting of the load. During lifting of the load the passage 17 does not compress the rope 2—it may slide through the passage 17.

As an example, a wire rope 2 having a working load limit of 1000 kg has an unstretched diameter of 10 mm. When this wire rope 2 is under tension of the 1000 kg working load limit, its stretchability may be such that the rope 2 will stretch to approximately 9 mm. Then, the internal diameter of the through passage 17 can be between 9-10 mm, e.g. 9.8 or 9.5 mm.

Obviously, the internal diameter of the passage 17 depends on the specific wire rope, in particular the unstretched diameter thereof, the certified working load limit thereof defining the load to be applied and the stretchability of the rope. It is noted that the working load limit may be between 1000-10000 kg. A larger load would increase the stretching of the rope, which leads to a larger difference between the unstretched diameter of the rope and the stretched diameter thereof. This is advantageous for the operation of the assembly.

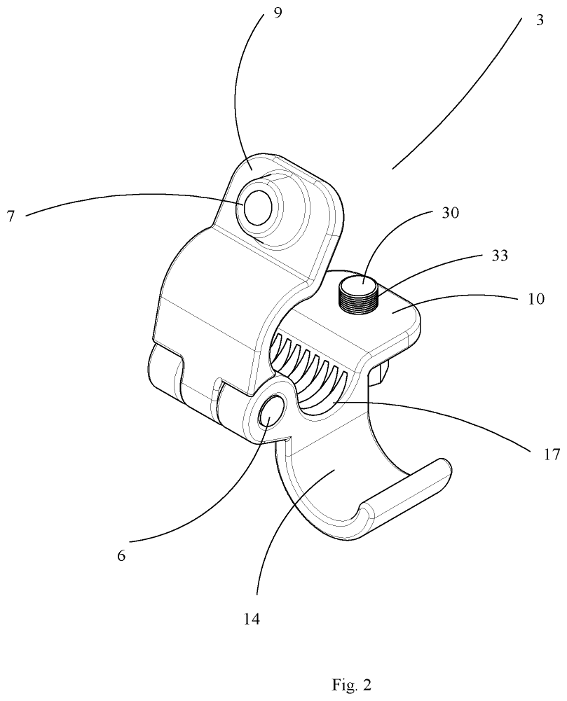

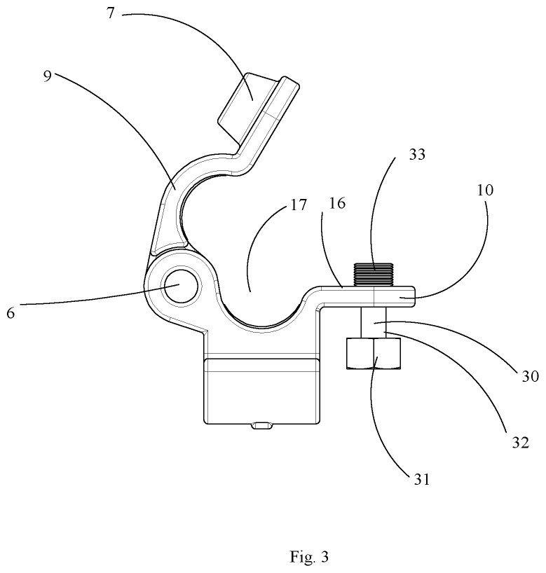

FIGS. 2 and 3 shows an example of a clamp 3 in an open, unused state.

FIG. 2 shows a perspective view of an improved clamp 3 according to embodiments herein. The clamp 3 is to be used in lifting assemblies 1 to secure the rope slings. The lifting assembly comprises a coupling element with at least one rope with an eye. In the figure, the clamp is shown in an open state, ready to receive a rope and hold a sling. The clamp 3 is provided with a first body member and a second body member. The body members together form the clamp, and they are hinged attached to each other, for example by a pin. It is not possible for the user to remove the pin, only to open or close the clamp by use of the hinge. Thus, the clamp is one integrated piece.

The internal surface of the through passage may be provided with ribs, as shown in the figure. Thereby, a frictional surface is provided when the through passage holds the rope. The frictional surface together with an appropriate size of the through passage adapted for the rope provides for a safe and secure grip of the rope when extending through the through passage.

FIG. 3 also shows the clamp in an open state, seen from the side. The clamp 3 is adapted for use in a lifting assembly 1 comprising a coupling element 5 with at least one rope 2 with an eye 5. The body members each comprises a respective receiving portion, in the example shown as two simple flat surfaces. The body members are attached to each other by an attachment arrangement such that the receiving portions when tighten to each other forms the through passage.

The first body member further comprises a hook element being adapted to receive and hold the eye of the rope when the rope extends through the eye to form a loop, and further through the through passage of the clamp. The attachment arrangement comprises a first and a second hole arranged in the respective receiving portion, and a coupling element arranged to pass through the first and second holes thereby attaching the receiving portions tight to each other, and arranged to still be attached to the first body member when the receiving portions are separated from each other as shown in the figure.

The coupling element, in the figure shown as a type of bolt, have a first part with a first diameter, and a second part with a second diameter. The first diameter is larger than the second diameter. It is to be noted that although open, the bolt is still attached to the second body member 10. The user may thus handle the clamp 3 as one single unit even when opened.

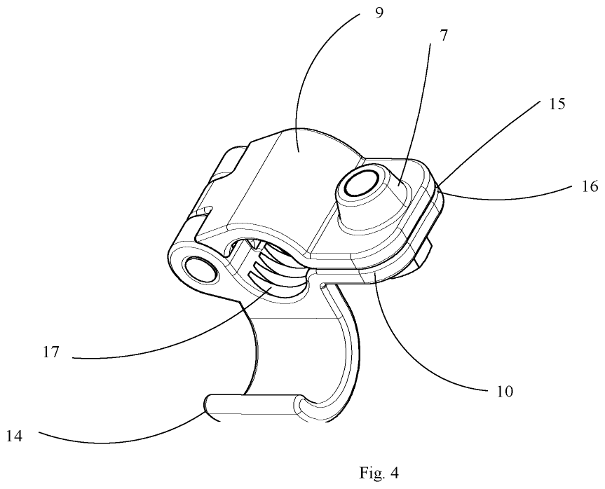

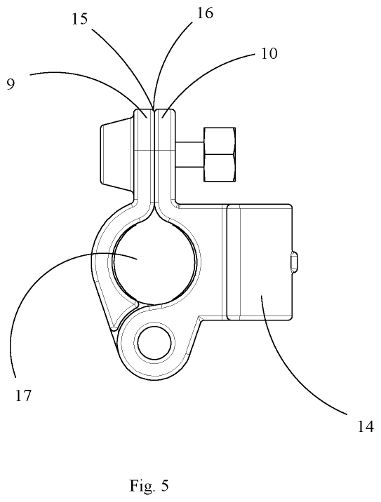

In FIGS. 4 and 5 the clamp is shown in a closed state. The bolt in screwed in the corresponding threads in the hole of the first body member 9 whereby the receiving portion 15, 16 of the body member 9, 10 are arranged tight to each other whereby the through passage 17 is provided. When in use, the rope with the load may slide in the through passage while the rope is under load and thus stretched. When the load is laid down to rest, the rope expires to a larger diameter and will therefore be hold tight in place in the through passage 17 of the clamp. Thereby, a bundle of pipes will be firmly and safe stacked together even when laid down on the ground.

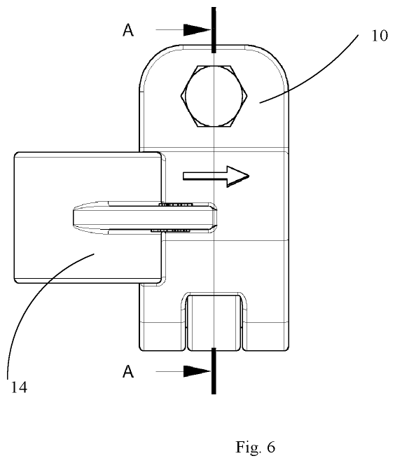

FIG. 6 shows the clamp from the underside. The hook is provided with a reinforcement part.

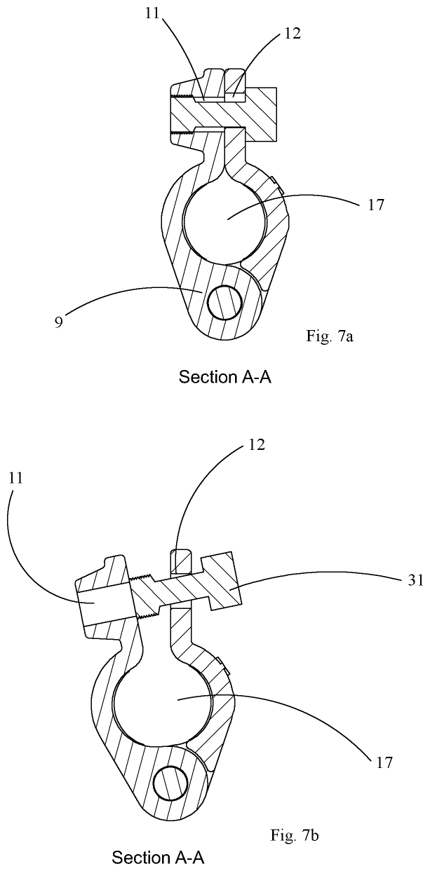

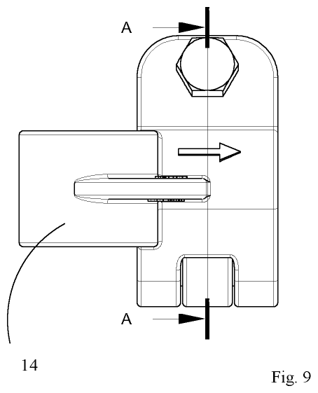

FIGS. 7a and 7b is cross sectional views at the arrows shown in FIG. 6 and FIG. 9. The attachment arrangement comprises a first and a second hole arranged in the respective receiving portion 15, 16, and a coupling element arranged to pass through the first and second holes thereby attaching the receiving portions to each other. In FIGS. 7a and 7b, the holes in the body members 9 and 10 are shown. In the exemplified embodiments, the diameter of the first and second holes are equal to each other, and provided with threads corresponding to the threads of the bolt. Thereby, the bolt will still be attached to the second body member 10 when the body members are separated, as shown in the figure. To loosen the bolt, the bolt needs to be screwed out through the threaded hole of the body member 10. If a user separates the body members and just let go of the bolt, it will still be attached and will not be lost. As may be seen in FIG. 7b, the smaller diameter of the mid part of the bolt allows for the body member 9 and 10 to be separated from each other without releasing the bolt from the body member 10. Although loose, the bolt will still be attached to the body member 10.

As best seen in FIG. 7a, the first and second holes are displaced in relation to each other. This is especially advantageous when the body members 9 and 10 are to be separated from each other. The displacement of the holes prevent the bolt from being screwed into the threads of the hole in the second member 9 when it has been screwed out from the hole in the first body member 9 since the displacement provide for a stop for the bolt when the receiving part 15, 16 are tight together. Therefore, the body members may be separated at the same time as the bolt is prevented from be loosened. The displacement of the holes is further advantageous as best shown in FIG. 7b, where the bolt is in a position to be screwed into the hole of the first body member 9 without the need of the receiving portions 15, 16 being exactly tight positioned together. The displacement of the holes enables this. Further, the different parts of the bolts being of different diameter also enables this thank to allowed movements of the bolt. When in use, this enables the user to apply the bolt into the threads while the clamp is still partly open.

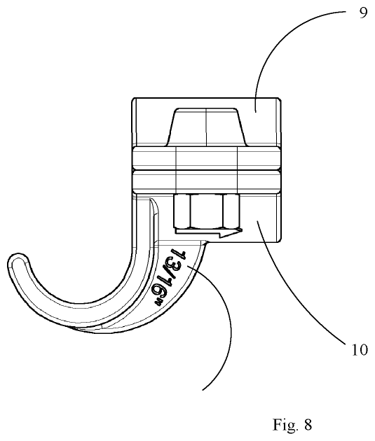

FIG. 8 shows the clamp from the side in a closed state. The body member 9 comprises a hook element 14 for holding the eye 5 of the rope 2 when the rope 2 passes through the eye 2 and the passage 17. The hook element 14 protrudes from the receiving portion 15 of the body part 9. The hook element 14 has a curved shape that is adapted for holding the eye 5. The hook element 14 has an open side 13 for inserting the eye 5 of the rope 2. During use, the rope 2 passes through the eye 5 behind the part of the eye 5 that extends in the hook element 14 and subsequently through the passage 17. The rope 2, when extending through the passage 17 of the clamp, locks the eye 5 of the rope 2 when received in the hook element 14. In practice, multiple bundles of pipes are stacked onto each other in a rough manner.

In embodiments herein, the closed side of the hook element is provided with a reinforcement part. The reinforcement enables a more slim hook but still very strong and able to hold large loads. The hook element has an open side for applying the eye of the rope on the hook element, and the rope, when extending through the passage of the clamp, confines the eye of the rope received in the hook element. The hook element protrudes with respect to the body parts, and the hook element has a curved shape that is adapted for holding the eye. The body member 9 further comprises an integrated hook element 14. The hook element 14 is adapted to hold the eye 5 of the rope 2 when the rope 2 extends through the eye 5 and through the through passage 17.

FIG. 9 shows the clamp from above. As seen, the hinge connecting the body members 9 and 10 to each other, have no protruding parts and it is not able to disconnect the body members from each other. Thus, the clamp has no loose parts which improves safety during use.

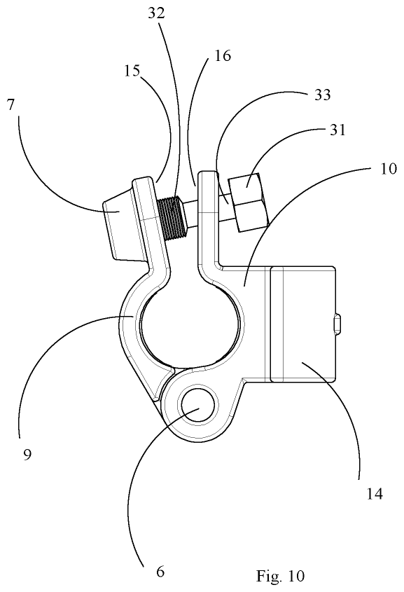

FIG. 10 shows the clamp from the side in a half-open state. The clamp is shown from the side in a half-open state. In the example in the figure, the diameter of the first part of the coupling element substantially corresponds to the diameter of the first hole. The bolt is provided with threads adapted to fit into corresponding threads arranged integrated with the first body member 9. Preferably, the threads are arranged in a housing 7 whereby the threads are protected from dirt and particles, and ice and snow. In this example, the coupling element is thus a bolt provided with threads and a head, and the first and second holes are provided with corresponding threads.

In alternative embodiments herein (not shown), one of the first and second holes may be elongated.

In embodiments herein a lifting assembly comprising such a clamp 3 is provided.

It is to be understood that the application is not to be limited to the embodiment described herein and shown. The skilled person will appreciate that the clamp may take various alternative forms within the scope of the claims.

1. A clamp for use in a lifting assembly comprising a coupling element with at least one rope with an eye, said clamp comprising:
a first body member and
a second body member,
which the first and second body members each comprises a respective receiving portion, wherein the first and second body members are attached to each other by an attachment arrangement such that the receiving portions form a through passage,
wherein the first body member further comprises a hook element being adapted to receive and hold the eye of the rope when the rope extends through the eye to form a loop, and through the through passage of the clamp,
wherein said attachment arrangement comprises:
a first and a second hole arranged in said respective receiving portion, and
a coupling element arranged to pass through said first and second holes thereby attaching the receiving portions to each other, and arranged to be attached to the first body member when the receiving portions are separated from each other.

2. The clamp according to claim 1, wherein said coupling element has a first part with a first diameter, and a second part with a second diameter, wherein said first diameter is larger than said second diameter.

3. The clamp according to claim 2, wherein the diameter of said first part of the coupling element substantially corresponds to the diameter of the first hole.

4. The clamp according to claim 2, wherein the diameter of the first and second holes are equal to each other.

5. The clamp according to claim 1, wherein one of said first and second holes is elongated.

6. The clamp according to claim 1, wherein said first and second holes are displaced in relation to each other.

7. The clamp according to claim 1, wherein said coupling element is a bolt provided with threads and a head, and wherein said first and second holes are provided with corresponding threads.

8. The clamp according to claim 1, wherein the hook element protrudes with respect to the body parts and wherein the hook element has a curved shape that is adapted for holding the eye.

9. The clamp according to claim 1, wherein the hook element has an open side for applying the eye of the rope on the hook element, and wherein the rope, when extending through the passage of the clamp, confines the eye of the rope received in the hook element.

10. The clamp according to claim 1, wherein the closed side of the hook element is provided with a reinforcement part.

11. A lifting assembly comprising the clamp according to claim 1.

12. A method comprising holding a rope with the clamp according to claim 1.
